(19) United States
(12) Patent Application Publication
(10) Pub. No.: US 2019/0253641 A1
(43) Pub. Date: Aug. 15, 2019

(54) DETECTION PROCESSING DEVICE OF WORK MACHINE, AND DETECTION PROCESSING METHOD OF WORK MACHINE

(71) Applicant: Komatsu Ltd., Tokyo (JP)

(72) Inventors: Toyohisa Matsuda, Tokyo (JP); Taiki Sugawara, Tokyo (JP); Toshihiko Kouda, Tokyo (JP)

(21) Appl. No.: 16/332,861

(22) PCT Filed: Sep. 29, 2017
(86) PCT No.: PCT/JP2017/035610

§ 371 Date: Mar. 13, 2019

(30) Foreign Application Priority Data
Sep. 30, 2016 (JP) 2016-195015

(51) Int. Cl. H04N 5/272; E02F 9/26; G01C 3/06

(52) U.S. Cl. CPC H04N 5/272; G01C 3/06; E02F 9/26

(57) ABSTRACT

A detection processing device, of a work machine, includes a measurement data acquisition unit which acquires measurement data of a target that is measured by a measurement device provided at a work machine, a working equipment position data calculation unit which calculates working equipment position data indicating a position of a working equipment of the work machine, and a three-dimensional data calculation unit which calculates target data that is three-dimensional data in which at least a part of the working equipment is removed, based on the measurement data and the working equipment position data.

### FIELD

The present invention relates to a detection processing device of a work machine, and a detection processing method of the work machine.

### BACKGROUND

There is known a work machine on which an imaging device is installed. Patent Literature 1 discloses a technique for creating construction plan image data based on construction plan data and position information of a stereo camera, for combining the construction plan image data and current state image data captured by the stereo camera, and for three-dimensionally displaying a combined synthetic image on a three-dimensional display device.

### CITATION LIST

### Patent Literature

Patent Literature 1: Japanese Patent Application Laid-Open No. 2013-036243 A

### SUMMARY

### Technical Problem

When a landform in front of a work machine is captured by an imaging device provided at the work machine, working equipment of the work machine is possibly also included and shown. Working equipment that is included and shown in image data acquired by the imaging device is a noise component, and makes acquisition of desirable three-dimensional data of the landform difficult. Inclusion of the working equipment may be prevented by raising the working equipment at the time of capturing the landform by the imaging device. However, if the working equipment is raised every time capturing is performed by the imaging device, work efficiency is reduced.

An aspect of the present invention has its object to provide a detection processing device of a work machine and a detection processing method of the work machine which enable acquisition of desirable three-dimensional data while suppressing reduction in work efficiency.

### Solution to Problem

According to a first aspect of the present invention, a detection processing device of a work machine comprises: a measurement data acquisition unit which acquires measurement data of a target that is measured by a measurement device provided at a work machine; a working equipment position data calculation unit which calculates working equipment position data indicating a position of a working equipment of the work machine; and a three-dimensional data calculation unit which calculates target data that is three-dimensional data in which at least a part of the working equipment is removed, based on the measurement data and the working equipment position data.

According to a second aspect of the present invention, a detection processing device of a work machine, comprises: a measurement data acquisition unit which acquires measurement data of a target that is measured by a measurement device provided at a work machine; a position data acquisition unit which acquires position data of another work machine; and a three-dimensional data calculation unit which calculates target data that is three-dimensional data in which at least a part of the other work machine is removed, based on the measurement data and the position data of the other work machine.

According to a third aspect of the present invention, a detection processing method of a work machine, comprises: acquiring measurement data of a target that is measured by a measurement device provided at a work machine; calculating working equipment position data indicating a position of a working equipment of the work machine; and calculating target data that is three-dimensional data in which at least a part of the working equipment is removed, based on the measurement data and the working equipment position data.

According to a fourth aspect of the present invention, a detection processing method of a work machine, comprises: acquiring measurement data of a target that is measured by a measurement device provided at a work machine; and calculating target data that is three-dimensional data in which at least a part of another work machine is removed, based on the measurement data and position data of the other work machine.

### ADVANTAGEOUS EFFECTS OF INVENTION

According to an aspect of the present invention, a detection processing device of a work machine and a detection processing method of the work machine which enable acquisition of desirable three-dimensional data while suppressing reduction in work efficiency are provided.

### BRIEF DESCRIPTION OF DRAWINGS

FIG. 1 is a perspective view illustrating an example of a work machine according to a first embodiment;

FIG. 2 is a perspective view illustrating an example of an imaging device according to the first embodiment;

FIG. 3 is a side view schematically illustrating the work machine according to the first embodiment;

FIG. 4 is a diagram schematically illustrating an example of a control system of the work machine and a shape measurement system according to the first embodiment;

FIG. 5 is a functional block diagram illustrating an example of a detection processing device according to the first embodiment;

FIG. 6 is a schematic diagram for describing a method of calculating three-dimensional data by a pair of imaging devices according to the first embodiment;

FIG. 7 is a flowchart illustrating an example of a shape measurement method according to the first embodiment;

FIG. 8 is a diagram illustrating an example of image data according to the first embodiment;

FIG. 9 is a flowchart illustrating an example of a shape measurement method according to a second embodiment; and

FIG. 10 is a diagram schematically illustrating an example of a shape measurement method according to a third embodiment.

### DESCRIPTION OF EMBODIMENTS

Hereinafter, embodiments according to the present invention will be described with reference to the drawings, but the present invention is not limited thereto. Structural elements of the embodiments described below may be combined as appropriate. Furthermore, use of one or some of the structural elements may be omitted.

In the following description, a positional relationship of units will be described by defining a three-dimensional global coordinate system (Xg, Yg, Zg), a three-dimensional vehicle body coordinate system (Xm, Ym, Zm), and a three-dimensional camera coordinate system (Xs, Ys, Zs).

The global coordinate system is defined by an Xg-axis in a horizontal plane, a Yg-axis perpendicular to the Xg-axis in the horizontal plane, and a Zg-axis perpendicular to the Xg-axis and the Yg-axis. A rotational or inclination direction relative to the Xg-axis is taken as a θXg direction, a rotational or inclination direction relative to the Yg-axis as a θYg direction, and a rotational or inclination direction relative to the Zg-axis as a θZg direction. The Zg-axis direction is a vertical direction.

The vehicle body coordinate system is defined by an Xm-axis extending in one direction with respect to an origin set on a vehicle body of a work machine, a Ym-axis perpendicular to the Xm-axis, and a Zm-axis perpendicular to the Xm-axis and the Ym-axis. An Xm-axis direction is a front-back direction of the work machine, a Ym-axis direction is a vehicle width direction of the work machine, and a Zm-axis direction is a top-bottom direction of the work machine.

The camera coordinate system is defined by an Xs-axis extending in one direction with respect to an origin set on an imaging device, a Ys-axis perpendicular to the Xs-axis, and a Zs-axis perpendicular to the Xs-axis and the Ys-axis. An Xs-axis direction is a top-bottom direction of the imaging device, a Ys-axis direction is a width direction of the imaging device, and a Zs-axis direction is a front-back direction of the imaging device. The Zs-axis direction is parallel to an optical axis of an optical system of the imaging device.

### First Embodiment

### Work Machine

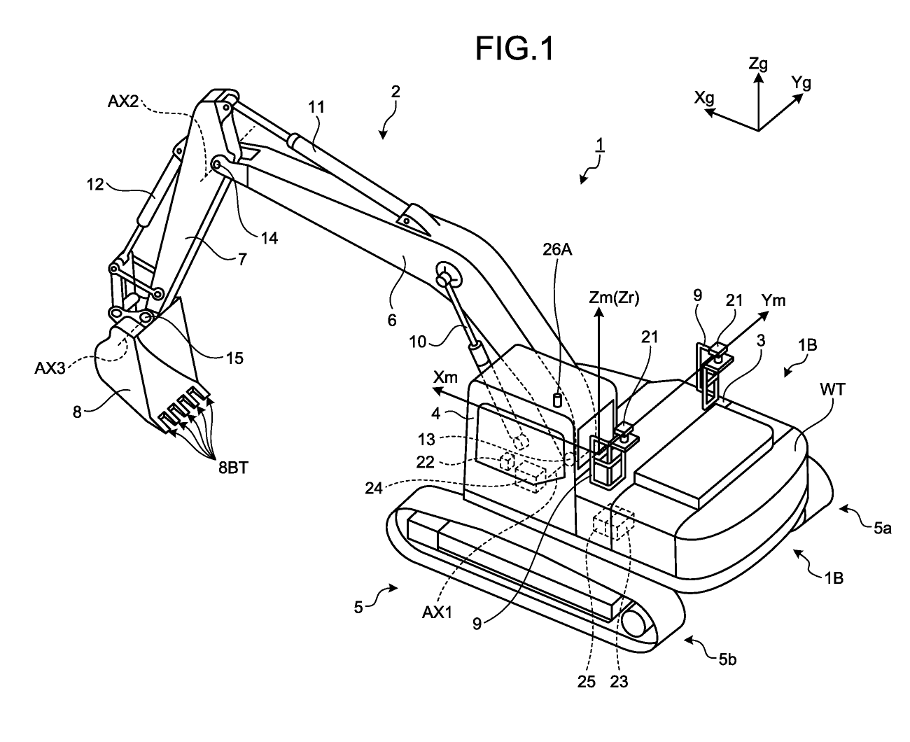

FIG. 1 is a perspective view illustrating an example of a work machine 1 according to a present embodiment. In the present embodiment, a description is given citing an excavator as the work machine 1. In the following description, the work machine 1 is referred to as the excavator 1 as appropriate.

As illustrated in FIG. 1 the excavator 1 includes a vehicle body 1B and working equipment 2. The vehicle body 1B includes a swinging body 3, and a traveling body 5 that supports the swinging body 3 in a swingable manner.

The swinging body 3 is capable of swinging around a swing axis Zr. The swing axis Zr and the Zm-axis are parallel to each other. The swinging body 3 includes a cab 4. A hydraulic pump and an internal combustion engine are disposed in the swinging body 3. The traveling body 5 includes crawler belts 5a, 5b. The excavator 1 travels by rotation of the crawler belts 5a, 5b.

The working equipment 2 is coupled to the swinging body 3. The working equipment 2 includes a boom 6 that is coupled to the swinging body 3, an arm 7 that is coupled to the boom 6, a bucket 8 that is coupled to the arm 7, a boom cylinder 10 for driving the boom 6, an arm cylinder 11 for driving the arm 7, and a bucket cylinder 12 for driving the bucket 8. The boom cylinder 10, the arm cylinder 11, and the bucket cylinder 12 are each a hydraulic cylinder that is driven by hydraulic pressure.

The boom 6 is rotatably coupled to the swinging body 3 by a boom pin 13. The arm 7 is rotatably coupled to a distal end portion of the boom 6 by an arm pin 14. The bucket 8 is rotatably coupled to a distal end portion of the arm 7 by a bucket pin 15. The boom pin 13 includes a rotation axis AX1 of the boom 6 relative to the swinging body 3. The arm pin 14 includes a rotation axis AX2 of the arm 7 relative to the boom 6. The bucket pin 15 includes a rotation axis AX3 of the bucket 8 relative to the arm 7. The rotation axis AX1 of the boom 6, the rotation axis AX2 of the arm 7, and the rotation axis AX3 of the bucket 8 are parallel to the Ym-axis of the vehicle body coordinate system.

The bucket 8 is a type of work tool. Additionally, the work tool to be coupled to the arm 7 is not limited to the bucket 8. The work tool to be coupled to the arm 7 may be a tilt bucket, or a rock drill attachment including a slope bucket or a rock drill tip, for example.

In the present embodiment, a position of the swinging body 3 defined in the global coordinate system (Xg, Yg, Zg) is detected. The global coordinate system is a coordinate system that takes an origin fixed in the earth as a reference. The global coordinate system is a coordinate system that is defined by a global navigation satellite system (GNSS). The GNSS refers to the global navigation satellite system. As an example of the global navigation satellite system, a global positioning system (GPS) may be cited. The GNSS includes a plurality of positioning satellites. The GNSS detects a position that is defined by coordinate data including latitude, longitude, and altitude.

The vehicle body coordinate system (Xm, Ym, Zm) is a coordinate system that takes an origin fixed in the swinging body 3 as a reference. The origin of the vehicle body coordinate system is a center of a swing circle of the swinging body 3, for example. The center of the swing circle is on the swing axis Zr of the swinging body 3.

The excavator 1 includes a working equipment angle detector 22 for detecting an angle of the working equipment 2, a position detector 23 for detecting a position of the swinging body 3, a posture detector 24 for detecting a posture of the swinging body 3, and an orientation detector 25 for detecting an orientation of the swinging body 3.

### Imaging Device

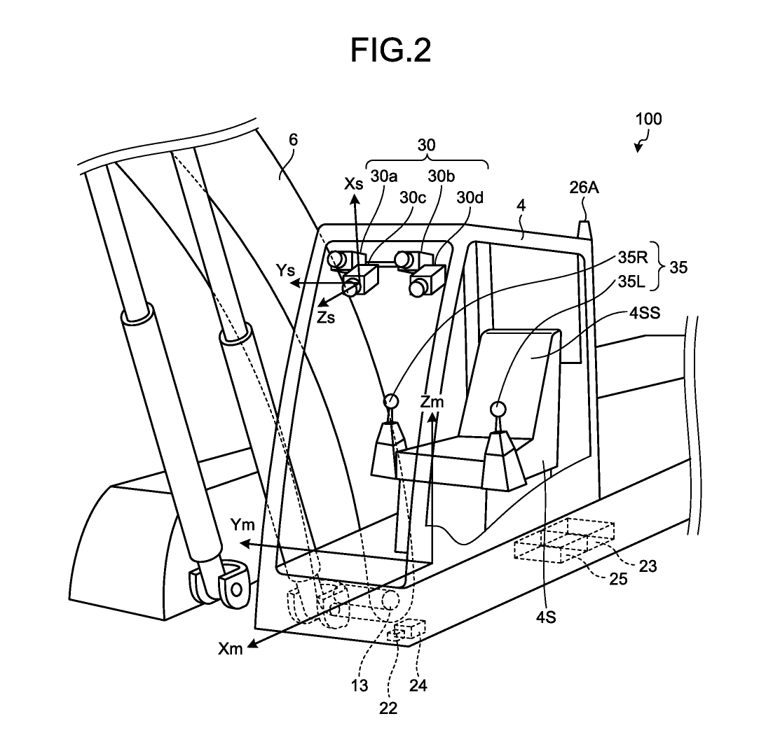

FIG. 2 is a perspective view illustrating an example of an imaging device 30 according to the present embodiment. FIG. 2 is a perspective view of and around the cab 4 of the excavator 1.

As illustrated in FIG. 2, the excavator 1 includes the imaging device 30. The imaging device 30 is provided at the excavator 1, and functions as a measurement device for measuring a target in front of the excavator 1. The imaging device 30 captures a target in front of the excavator 1. Additionally, front of the excavator 1 refers to a +Xm direction of the vehicle body coordinate system, and refers to a direction in which the working equipment 2 is present with respect to the swinging body 3.

The imaging device 30 is provided inside the cab 4. The imaging device 30 is disposed at a front (+Xm direction) and at a top (+Zm direction) in the cab 4.

The top (+Zm direction) is a direction perpendicular to a ground contact surface of the crawler belts 5a, 5b, and is a direction away from the ground contact surface. The ground contact surface of the crawler belts 5a, 5b is a plane which is at a part where at least one of the crawler belts 5a, 5b comes into contact with the ground, and which is defined by at least three points which are not present on one straight line. A bottom (−Zm direction) is a direction opposite the top, and is a direction which is perpendicular to the ground contact surface of the crawler belts 5a, 5b, and which is toward the ground contact surface.

A driver's seat 4S and an operation device 35 are disposed in the cab 4. The driver's seat 4S includes a backrest 4SS. The front (+Xm direction) is a direction from the backrest 4SS of the driver's seat 4S toward the operation device 35. A back (−Xm direction) is a direction opposite the front, and is a direction from the operation device 35 toward the backrest 4SS of the driver's seat 4S. A front part of the swinging body 3 is a part at a front of the swinging body 3, and is a part on an opposite side from a counterweight WT of the swinging body 3. The operation device 35 is operated by a driver to operate the working equipment 2 and the swinging body 3. The operation device 35 includes a right operation lever 35R and a left operation lever 35L. The driver inside the cab 4 operates the operation device 35, and drives the working equipment 2 and swings the swinging body 3.

The imaging device 30 captures a capturing target that is present in front of the swinging body 3. In the present embodiment, the capturing target includes a work target which is to be worked on at a construction site. The work target includes an excavation target which is to be excavated by the working equipment 2 of the excavator 1. Additionally, the work target may be an excavation target which is to be excavated by the working equipment 2 of another excavator 1ot, or may be a work target which is to be worked on by a work machine different from the excavator 1 including the imaging device 30. The work target may be a work target which is to be worked on by a worker.

The work target is a concept including a work target which is not yet worked on, a work target which is being worked on, and a work target which has been worked on.

The imaging device 30 includes an optical system and an image sensor. The image sensor may be a couple charged device (CCD) image sensor or a complementary metal oxide semiconductor (CMOS) image sensor.

In the present embodiment, the imaging device 30 includes a plurality of imaging devices 30a, 30b, 30c, 30d. The imaging devices 30a, 30c are disposed more on a +Ym side (working equipment 2 side) than the imaging devices 30b, 30d are. The imaging device 30a and the imaging device 30b are disposed with a gap therebetween in the Ym-axis direction. The imaging device 30c and the imaging device 30d are disposed with a gap therebetween in the Ym-axis direction. The imaging devices 30a, 30b are disposed more on a +Zm side than the imaging devices 30c, 30d are. With respect to the Zm-axis direction, the imaging device 30a and the imaging device 30b are disposed at a substantially same position. With respect to the Zm-axis direction, the imaging device 30c and the imaging device 30d are disposed at a substantially same position.

A stereo camera is configured of a set of two imaging devices 30 among the four imaging devices 30 (30a, 30b, 30c, 30d). The stereo camera refers to a camera which is capable of also acquiring data of a capturing target with respect to a depth direction, by simultaneously capturing the capturing target from a plurality of different directions. In the present embodiment, a first stereo camera is configured of a set of the imaging devices 30a, 30b, and a second stereo camera is configured of a set of the imaging devices 30c, 30d.

In the present embodiment, the imaging devices 30a, 30b face upward (+Zm direction). The imaging devices 30c, 30d face downward (−Zm direction). Furthermore, the imaging devices 30a, 30c face forward (+Xm direction). The imaging devices 30b, 30d face slightly more toward the +Ym side (working equipment 2 side) than forward. That is, the imaging devices 30a, 30c face a front of the swinging body 3, and the imaging devices 30b, 30d face toward the imaging devices 30a, 30c. Alternatively, the imaging devices 30b, 30d may face the front of the swinging body 3, and the imaging devices 30a, 30c may face toward the imaging devices 30b, 30d.

The imaging device 30 stereoscopically captures a capturing target that is present in front of the swinging body 3. In the present embodiment, three-dimensional data of a work target is calculated by three-dimensionally measuring the work target using stereoscopic image data from at least one pair of imaging devices 30. The three-dimensional data of the work target is three-dimensional data of a surface (land surface) of the work target. The three-dimensional data of the work target includes three-dimensional shape data of the work target in the global coordinate system.

The camera coordinate system (Xs, Ys, Zs) is defined for each of the plurality of imaging devices 30 (30a, 30b, 30c, 30d). The camera coordinate system is a coordinate system that takes an origin fixed in the imaging device 30 as a reference. The Zs-axis of the camera coordinate system coincides with the optical axis of the optical system of the imaging device 30. In the present embodiment, of the plurality of imaging devices 30a, 30b, 30c, 30d, the imaging device 30c is set as a reference imaging device.

### Detection System

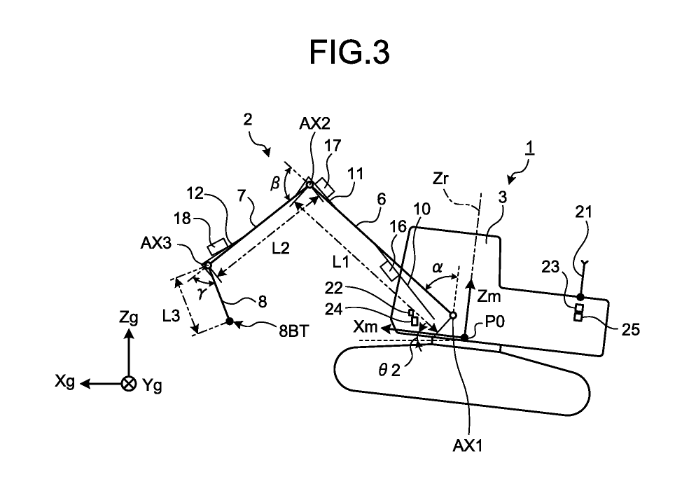

Next, a detection system of the excavator 1 according to the present embodiment will be described. FIG. 3 is a side view schematically illustrating the excavator 1 according to the present embodiment.

As illustrated in FIG. 3, the excavator 1 includes the working equipment angle detector 22 for detecting an angle of the working equipment 2, the position detector 23 for detecting a position of the swinging body 3, the posture detector 24 for detecting a posture of the swinging body 3, and the orientation detector 25 for detecting an orientation of the swinging body 3.

The position detector 23 includes a GPS receiver. The position detector 23 is provided in the swinging body 3. The position detector 23 detects an absolute position which is a position of the swinging body 3 defined in the global coordinate system. The absolute position of the swinging body 3 includes coordinate data in the Xg-axis direction, coordinate data in the Yg-axis direction, and coordinate data in the Zg-axis direction.

A pair of GPS antennas 21 are provided on the swinging body 3. In the present embodiment, the pair of GPS antennas 21 are provided on handrails 9 provided on an upper part of the swinging body 3. The pair of GPS antennas 21 are disposed in the Ym-axis direction of the vehicle body coordinate system. The pair of GPS antennas 21 are separated from each other by a specific distance. The pair of GPS antennas 21 receive radio waves from GPS satellites, and output, to the position detector 23, signals that are generated based on received radio waves. The position detector 23 detects absolute positions of the pair of GPS antennas 21, which are positions defined in the global coordinate system, based on the signals supplied by the pair of GPS antennas 21.

The position detector 23 calculates the absolute position of the swinging body 3 by performing a calculation process based on at least one of the absolute positions of the pair of GPS antennas 21. In the present embodiment, the absolute position of one of the GPS antennas 21 may be given as the absolute position of the swinging body 3. Alternatively, the absolute position of the swinging body 3 may be a position between the absolute position of one GPS antenna 21 and the absolute position of the other GPS antenna 21.

The posture detector 24 includes an inertial measurement unit (IMU). The posture detector 24 is provided in the swinging body 3. The posture detector 24 calculates an inclination angle of the swinging body 3 relative to a horizontal plane (XgYg plane) which is defined in the global coordinate system. The inclination angle of the swinging body 3 relative to the horizontal plane includes a roll angle θ1 indicating the inclination angle of the swinging body 3 in the Ym-axis direction (vehicle width direction), and a pitch angle θ2 indicating the inclination angle of the swinging body 3 in the Xm-axis direction (front-back direction).

The posture detector 24 detects acceleration and angular velocity that are applied to the posture detector 24. When the acceleration and angular velocity applied to the posture detector 24 are detected, acceleration and angular velocity applied to the swinging body 3 are detected. The posture of the swinging body 3 is derived from the acceleration and angular velocity that are applied to the swinging body 3.

The orientation detector 25 calculates the orientation of the swinging body 3 relative to a reference orientation that is defined in the global coordinate system, based on the absolute position of one GPS antenna 21 and the absolute position of the other GPS antenna 21. The reference orientation is north, for example. The orientation detector 25 calculates a straight line that connects the absolute position of one GPS antenna 21 and the absolute position of the other GPS antenna 21, and calculates the orientation of the swinging body 3 relative to the reference orientation based on an angle formed by the calculated straight line and the reference orientation. The orientation of the swinging body 3 relative to the reference orientation includes a yaw angle (orientation angle) θ3 that is formed by the reference orientation and the orientation of the swinging body 3.

The working equipment 2 includes a boom stroke sensor 16 which is disposed at the boom cylinder 10, and which is for detecting a boom stroke indicating a drive amount of the boom cylinder 10, an arm stroke sensor 17 which is disposed at the arm cylinder 11, and which is for detecting an arm stroke indicating a drive amount of the arm cylinder 11, and a bucket stroke sensor 18 which is disposed at the bucket cylinder 12, and which is for detecting a drive amount of the bucket cylinder 12.

The working equipment angle detector 22 detects an angle of the boom 6, an angle of the arm 7, and an angle of the bucket 8. The working equipment angle detector 22 calculates a boom angle α indicating an inclination angle of the boom 6 relative to the Zm-axis of the vehicle body coordinate system, based on the boom stroke detected by the boom stroke sensor 16. The working equipment angle detector 22 calculates an arm angle β indicating an inclination angle of the arm 7 relative to the boom 6, based on the arm stroke detected by the arm stroke sensor 17. The working equipment angle detector 22 calculates a bucket angle γ indicating an inclination angle of a blade tip 8BT of the bucket 8 relative to the arm 7, based on the bucket stroke detected by the bucket stroke sensor 18.

Additionally, the boom angle α, the arm angle β, and the bucket angle γ may be detected by an angle sensor provided at the working equipment 2, for example, without using the stroke sensors.

### Shape Measurement System

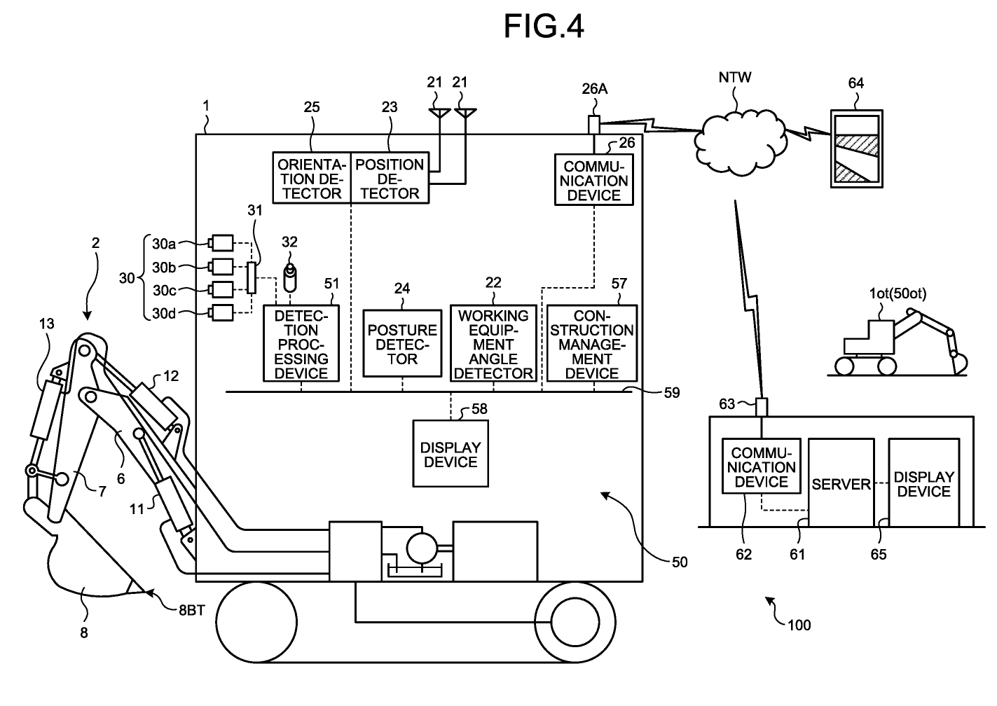

FIG. 4 is a diagram schematically illustrating an example of a shape measurement system 100 including a control system 50 of the excavator 1 and a server 61 according to the present embodiment.

The control system 50 is disposed in the excavator 1. The server 61 is provided at a remote location from the excavator 1. The control system 50 and the server 61 are capable of performing data communication with each other over a communication network NTW. In addition to the control system 50 and the server 61, a mobile terminal device 64 and a control system 50ot of the other excavator 1ot are connected to the communication network NTW. The control system 50 of the excavator 1, the server 61, the mobile terminal device 64, and the control system 50ot of the other excavator 1ot are capable of performing data communication with one another over the communication network NTW. The communication network NTW includes at least one of a mobile telephone network and the Internet. The communication network NTW may also include a wireless LAN (Local Area Network).

The control system 50 includes the plurality of imaging devices 30 (30a, 30b, 30c, 30d), a detection processing device 51, a construction management device 57, a display device 58, and a communication device 26.

The control system 50 also includes the working equipment angle detector 22, the position detector 23, the posture detector 24, and the orientation detector 25.

The detection processing device 51, the construction management device 57, the display device 58, the communication device 26, the position detector 23, the posture detector 24, and the orientation detector 25 are connected to a signal line 59, and are capable of performing data communication with one another. A communication standard adopted by the signal line 59 is a controller area network (CAN), for example.

The control system 50 includes a computer system. The control system 50 includes an arithmetic processing device including a processor such as a central processing unit (CPU), and storage devices including a non-volatile memory such as a random access memory (RAM) and a volatile memory such as a read only memory (ROM). A communication antenna 26a is connected to the communication device 26. The communication device 26 is capable of performing data communication, over the communication network NTW, with at least one of the server 61, the mobile terminal device 64, and the control system 50ot of the other excavator 1ot.

The detection processing device 51 calculates three-dimensional data of a work target based on a pair of pieces of image data of the work target captured by at least one pair of imaging devices 30. The detection processing device 51 calculates three-dimensional data indicating coordinates of a plurality of parts of the work target in a three-dimensional coordinate system, by performing stereoscopic image processing on the pair of pieces of image data of the work target. The stereoscopic image processing refers to a method of obtaining a distance to a capturing target based on two images that are obtained by observing a same capturing target from two different imaging devices 30. The distance to the capturing target is expressed by a range image visualizing data about the distance to the capturing target using shading, for example.

A hub 31 and an imaging switch 32 are connected to the detection processing device 51. The hub 31 is connected to the plurality of imaging devices 30a, 30b, 30c, 30d. Pieces of image data acquired by the imaging devices 30a, 30b, 30c, 30d are supplied to the detection processing device 51 through the hub 31. Additionally, the hub 31 may be omitted.

The imaging switch 32 is installed in the cab 4. In the present embodiment, when the imaging switch 32 is operated by the driver in the cab 4, a work target is captured by the imaging device 30. Additionally, in a state where the excavator 1 is in operation, capturing of a work target by the imaging device 30 may be automatically performed at predetermined intervals.

The construction management device 57 manages a state of the excavator 1, and a status of work of the excavator 1. For example, the construction management device 57 acquires completed work data indicating a result of work at an end stage of a day's work, and transmits the completed work data to at least one of the server 61 and the mobile terminal device 64. The construction management device 57 also acquires mid-work data indicating a result of work at a middle stage of a day's work, and transmits the mid-work data to at least one of the server 61 and the mobile terminal device 64.

The completed work data and the mid-work data include the three-dimensional data of the work target which is calculated by the detection processing device 51 based on the image data acquired by the imaging devices 30. That is, current landform data of the work target at a middle stage and an end stage of a day's work are transmitted to at least one of the server 61 and the mobile terminal device 64. Additionally, the construction management device 57 may transmit, in addition to the completed work data and the mid-work data, at least one of acquisition date/time data of image data acquired by the imaging device 30, acquisition location data, and identification data of the excavator 1 that acquired the image data, to at least one of the server 61 and the mobile terminal device 64. The identification data of the excavator 1 includes a model number of the excavator 1, for example.

The display device 58 includes a flat panel display such as a liquid crystal display (LCD) or an organic electroluminescence display (OELD).

The mobile terminal device 64 is possessed by a manager managing work of the excavator 1, for example.

The server 61 includes a computer system. The server 61 includes an arithmetic processing device including a processor such as a CPU, and storage devices including a volatile memory such as a RAM and a non-volatile memory such as a ROM. A communication device 62 and a display device 65 are connected to the server 61. The communication device 62 is connected to a communication antenna 63. The communication device 62 is capable of performing data communication, over the communication network NTW, with at least one of the control system 50 of the excavator 1, the mobile terminal device 64, and the control system 50ot of the other excavator 1ot.

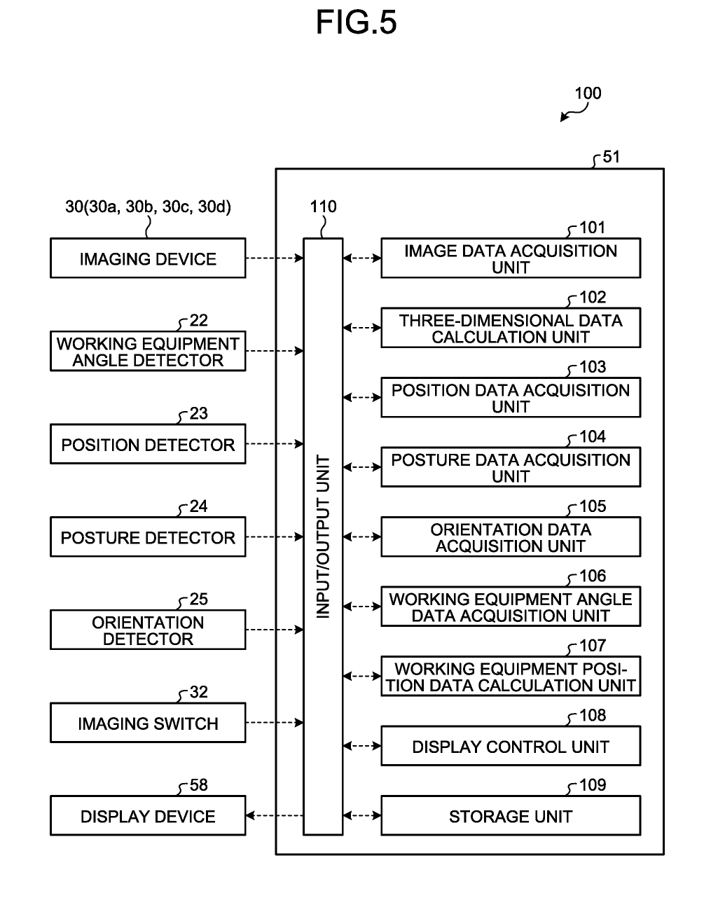

FIG. 5 is a functional block diagram illustrating an example of the detection processing device 51 according to the present embodiment. The detection processing device 51 includes a computer system including an arithmetic processing device including a processor, storage devices including a non-volatile memory and a volatile memory, and an input/output interface.

The detection processing device 51 includes an image data acquisition unit 101, a three-dimensional data calculation unit 102, a position data acquisition unit 103, a posture data acquisition unit 104, an orientation data acquisition unit 105, a working equipment angle data acquisition unit 106, a working equipment position data calculation unit 107, a display control unit 108, a storage unit 109, and an input/output unit 110.

Functions of the image data acquisition unit 101, the three-dimensional data calculation unit 102, the position data acquisition unit 103, the posture data acquisition unit 104, the orientation data acquisition unit 105, the working equipment angle data acquisition unit 106, the working equipment position data calculation unit 107, and the display control unit 108 are realized by the arithmetic processing device. A function of the storage unit 109 is realized by the storage devices. A function of the input/output unit 110 is realized by the input/output interface.

The imaging device 30, the working equipment angle detector 22, the position detector 23, the posture detector 24, the orientation detector 25, the imaging switch 32, and the display device 58 are connected to the input/output unit 110. The image data acquisition unit 101, the three-dimensional data calculation unit 102, the position data acquisition unit 103, the posture data acquisition unit 104, the orientation data acquisition unit 105, the working equipment angle data acquisition unit 106, the working equipment position data calculation unit 107, the display control unit 108, the storage unit 109, the imaging device 30, the working equipment angle detector 22, the position detector 23, the posture detector 24, the orientation detector 25, the imaging switch 32, and the display device 58 are capable of performing data communication through the input/output unit 110.

The image data acquisition unit 101 acquires, from at least one pair of imaging devices 30 provided at the excavator 1, pieces of image data of a work target captured by the pair of imaging devices 30. That is, the image data acquisition unit 101 acquires stereoscopic image data from at least one pair of imaging devices 30. The image data acquisition unit 101 functions as a measurement data acquisition unit for acquiring image data (measurement data) of a work target, in front of the excavator 1, which is captured (measured) by the imaging device 30 (measurement device) provided at the excavator 1.

The three-dimensional data calculation unit 102 calculates three-dimensional data of the work target based on the image data acquired by the image data acquisition unit 101. The three-dimensional data calculation unit 102 calculates three-dimensional shape data of the work target in the camera coordinate system, based on the image data acquired by the image data acquisition unit 101.

The position data acquisition unit 103 acquires position data of the excavator 1 from the position detector 23. The position data of the excavator 1 includes position data indicating the position of the swinging body 3 in the global coordinate system detected by the position detector 23.

The posture data acquisition unit 104 acquires posture data of the excavator 1 from the posture detector 24. The posture data of the excavator 1 includes posture data indicating the posture of the swinging body 3 in the global coordinate system detected by the posture detector 24.

The orientation data acquisition unit 105 acquires orientation data of the excavator 1 from the orientation detector 25. The orientation data of the excavator 1 includes orientation data indicating the orientation of the swinging body 3 in the global coordinate system detected by the orientation detector 25.

The working equipment angle data acquisition unit 106 acquires working equipment angle data indicating the angle of the working equipment 2 from the working equipment angle detector 22. The working equipment angle data includes the boom angle α, the arm angle β, and the bucket angle γ.

The working equipment position data calculation unit 107 calculates working equipment position data indicating the position of the working equipment 2. The working equipment position data includes position data of the boom 6, position data of the arm 7, and position data of the bucket 8.

The working equipment position data calculation unit 107 calculates the position data of the boom 6, the position data of the arm 7, and the position data of the bucket 8, in the vehicle body coordinate system, based on the working equipment angle data acquired by the working equipment angle data acquisition unit 106 and working equipment data that is stored in the storage unit 109. The pieces of position data of the boom 6, the arm 7, and the bucket 8 include coordinate data of a plurality of parts of the boom 6, the arm 7, and the bucket 8, respectively.

Furthermore, the working equipment position data calculation unit 107 calculates the position data of the boom 6, the arm 7, and the bucket 8 in the global coordinate system, based on the position data of the swinging body 3 acquired by the position data acquisition unit 103, the posture data of the swinging body 3 acquired by the posture data acquisition unit 104, the orientation data of the swinging body 3 acquired by the orientation data acquisition unit 105, the working equipment angle data acquired by the working equipment angle data acquisition unit 106, and the working equipment data that is stored in the storage unit 109.

The working equipment data includes design data or specification data of the working equipment 2. The design data of the working equipment 2 includes three-dimensional CAD data of the working equipment 2. The working equipment data includes at least one of outer shape data of the working equipment 2 and dimensional data of the working equipment 2. In the present embodiment, as illustrated in FIG. 3, the working equipment data includes a boom length L1, an arm length L2, and a bucket length L3. The boom length L1 is a distance between the rotation axis AX1 and the rotation axis AX2. The arm length L2 is a distance between the rotation axis AX2 and the rotation axis AX3. The bucket length L3 is a distance between the rotation axis AX3 and the blade tip 8BT of the bucket 8.

The three-dimensional data calculation unit 102 calculates the three-dimensional data of the work target in the vehicle body coordinate system, based on the image data of the work target acquired by the image data acquisition unit 101. The three-dimensional data of the work target in the vehicle body coordinate system includes three-dimensional shape data of the work target in the vehicle body coordinate system. The three-dimensional data calculation unit 102 calculates the three-dimensional data of the work target in the vehicle body coordinate system by performing coordinate transformation on the three-dimensional data of the work target in the camera coordinate system.

Furthermore, the three-dimensional data calculation unit 102 calculates the three-dimensional data of the work target in the global coordinate system, based on the position data of the swinging body 3 acquired by the position data acquisition unit 103, the posture data of the swinging body 3 acquired by the posture data acquisition unit 104, the orientation data of the swinging body 3 acquired by the orientation data acquisition unit 105, and the image data of the work target acquired by the image data acquisition unit 101. The three-dimensional data of the work target in the global coordinate system includes three-dimensional shape data of the work target in the global coordinate system. The three-dimensional data calculation unit 102 calculates the three-dimensional data of the work target in the global coordinate system by performing coordinate transformation on the three-dimensional data of the work target in the vehicle body coordinate system.

The display control unit 108 causes the display device 58 to display the three-dimensional data of the work target calculated by the three-dimensional data calculation unit 102. The display control unit 108 converts the three-dimensional data of the work target calculated by the three-dimensional data calculation unit 102 into display data in a display format that can be displayed by the display device 58, and causes the display device 58 to display the display data.

### Three-Dimensional Processing

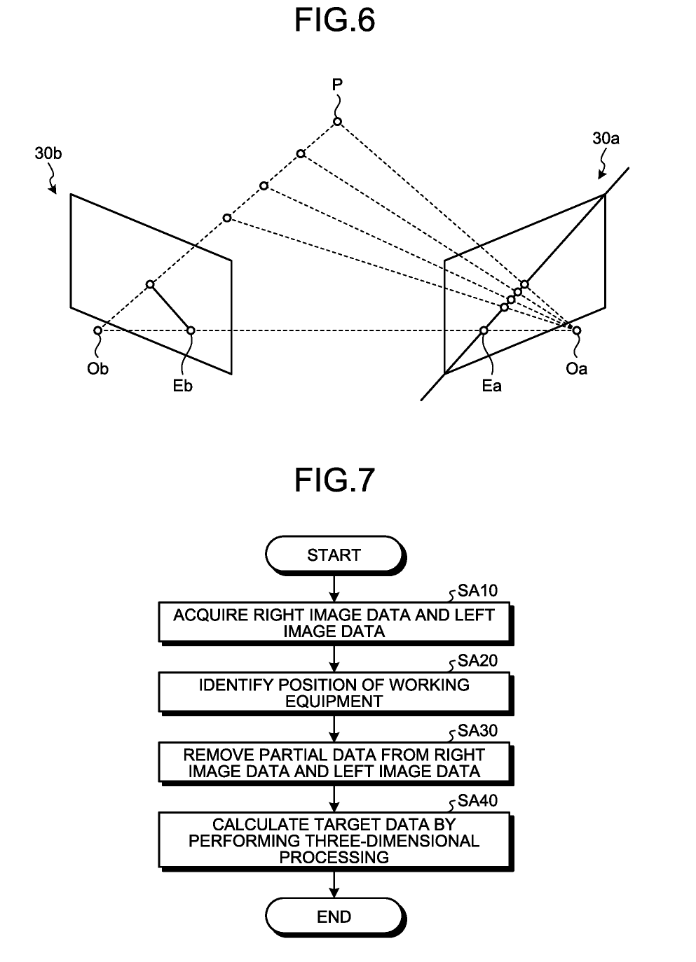

FIG. 6 is a schematic diagram for describing a method of calculating three-dimensional data by a pair of imaging devices 30 according to the present embodiment. In the following, a description is given of a method of calculating the three-dimensional data by a pair of imaging devices 30a, 30b. Three-dimensional processing for calculating the three-dimensional data includes a so-called stereoscopic measurement process. Additionally, the method of calculating the three-dimensional data by the pair of imaging devices 30a, 30b, and the method of calculating the three-dimensional data by a pair of imaging devices 30c, 30d are the same.

Imaging device position data, which is measurement device position data regarding the pair of imaging devices 30a, 30b, is stored in the storage unit 109. The imaging device position data includes the position and posture of each of the imaging device 30a and the imaging device 30b. The imaging device position data also includes relative positions of the pair of imaging device 30a and the imaging device 30b with respect to each other. The imaging device position data is known data which can be grasped from the design data or the specification data of the imaging devices 30a, 30b. The imaging device position data indicating the positions of the imaging devices 30a, 30b includes at least one of a position of an optical center Oa and a direction of an optical axis of the imaging device 30a, a position of an optical center Ob and a direction of an optical axis of the imaging device 30b, and a dimension of a baseline connecting the optical center Oa of the imaging device 30a and the optical center Ob of the imaging device 30b.

In FIG. 6, a measurement point P present in a three-dimensional space is projected onto projection surfaces of the pair of imaging devices 30a, 30b. An image at the measurement point P and an image at a point Eb on the projection surface of the imaging device 30b are projected onto the projection surface of the imaging device 30a, and an epipolar line is thereby defined. In the same manner, the image at the measurement point P and an image at a point Ea on the projection surface of the imaging device 30a are projected onto the projection surface of the imaging device 30b, and an epipolar line is thereby defined. An epipolar plane is defined by the measurement point P, the point Ea, and the point Eb.

In the present embodiment, the image data acquisition unit 101 acquires image data that is captured by the imaging device 30a, and image data that is captured by the imaging device 30b. The image data that is captured by the imaging device 30a and the image data that is captured by the imaging device 30b are each two-dimensional image data that is projected onto the projection surface. In the following description, the two-dimensional image data captured by the imaging device 30a will be referred to as right image data as appropriate, and the two-dimensional image data captured by the imaging device 30b will be referred to as left image data as appropriate.

The right image data and the left image data acquired by the image data acquisition unit 101 are output to the three-dimensional data calculation unit 102. The three-dimensional data calculation unit 102 calculates three-dimensional coordinate data of the measurement point P in the camera coordinate system, based on coordinate data of the image at the measurement point P in the right image data, coordinate data of the image at the measurement point P in the left image data, and the epipolar plane, which are defined in the camera coordinate system.

With respect to the three-dimensional image data, three-dimensional coordinate data is calculated for each of a plurality of measurement points P of the work target based on the right image data and the left image data. The three-dimensional data of the work target is thereby calculated.

In the present embodiment, in the stereoscopic image processing, the three-dimensional data calculation unit 102 calculates the three-dimensional data including the three-dimensional coordinate data of the plurality of measurement points P in the camera coordinate system, and then, by performing coordinate transformation, calculates the three-dimensional data including the three-dimensional coordinate data of the plurality of measurement points P in the vehicle body coordinate system.

### Shape Measurement Method

Next, a shape measurement method according to the present embodiment will be described. When a work target is captured by the imaging device 30, at least a part of the working equipment 2 of the excavator 1 is possibly included and shown in the image data that is captured by the imaging device 30. The working equipment 2 that is included and shown in the image data captured by the imaging device 30 is a noise component, and makes acquisition of desirable three-dimensional data of the work target difficult.

In the present embodiment, the three-dimensional data calculation unit 102 calculates target data that is three-dimensional data from which at least a part of the working equipment 2 is removed, based on the image data acquired by the image data acquisition unit 101 and the working equipment position data calculated by the working equipment position data calculation unit 107.

In the present embodiment, the three-dimensional data calculation unit 102 calculates the working equipment position data in the camera coordinate system by performing coordinate transformation on the working equipment position data in the vehicle body coordinate system calculated by the working equipment position data calculation unit 107. The three-dimensional data calculation unit 102 identifies the position of the working equipment 2 in the image data acquired by the image data acquisition unit 101, based on the working equipment position data in the camera coordinate system, and calculates the target data, which is the three-dimensional data from which at least a part of the working equipment 2 is removed. The three-dimensional data calculation unit 102 calculates target data that is the three-dimensional data in the vehicle body coordinate system by performing coordinate transformation on the target data that is the calculated three-dimensional data in the camera coordinate system.

FIG. 7 is a flowchart illustrating an example of the shape measurement method according to the present embodiment. The image data acquisition unit 101 acquires the right image data and the left image data from the imaging devices 30 (step SA10). As described above, the right image data and the left image data are each two-dimensional image data.

The three-dimensional data calculation unit 102 calculates the working equipment position data in the camera coordinate system by performing coordinate transformation on the working equipment position data in the vehicle body coordinate system calculated by the working equipment position data calculation unit 107. The three-dimensional data calculation unit 102 identifies the position of the working equipment 2 in each of the right image data and the left image data, based on the working equipment position data in the camera coordinate system (step SA20).

As described above, the imaging device position data indicating the positions of the imaging devices 30a, 30b is stored in the storage unit 109. The three-dimensional data calculation unit 102 may identify the position of the working equipment 2 in the right image data and the position of the working equipment 2 in the left image data, based on the imaging device position data and the working equipment position data.

For example, if the position of the working equipment 2 in the vehicle body coordinate system and the position and posture (direction) of the imaging device 30 in the vehicle body coordinate system are known, a range, in a capturing range of the imaging device 30 (range of a field of view of the optical system of the imaging device 30), where the working equipment 2 is shown is identified. The three-dimensional data calculation unit 102 may calculate the position of the working equipment 2 in the right image data and the position of the working equipment 2 in the left image data, based on relative positions of the working equipment 2 and the imaging devices 30 with respect to each other.

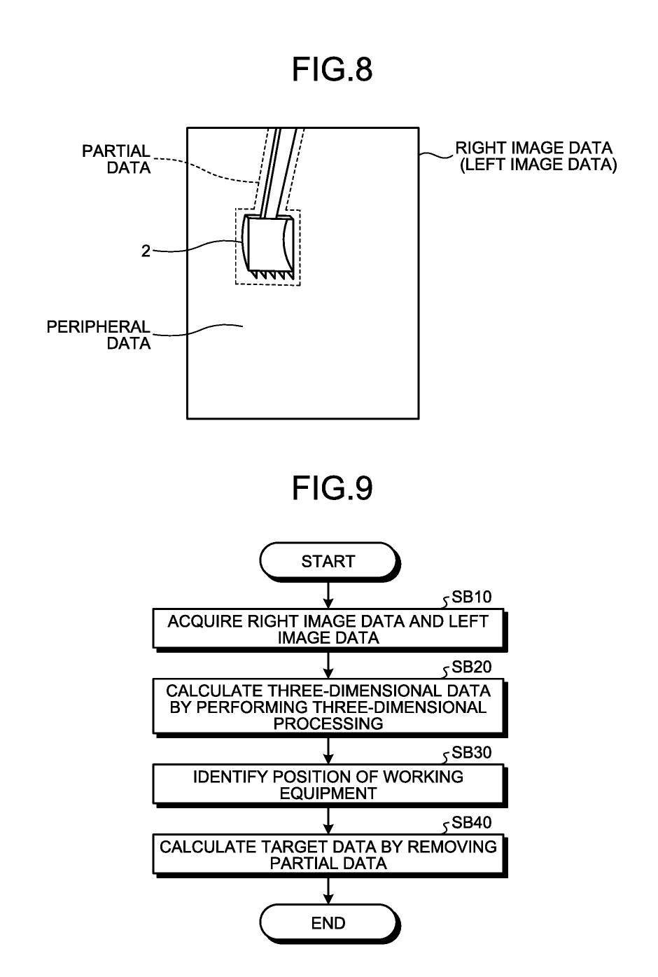

FIG. 8 is a diagram illustrating an example of the right image data according to the present embodiment. In the description given with reference to FIG. 8, the right image data is described, but the same thing can be said for the left image data.

As illustrated in FIG. 8, the working equipment 2 is possibly included and shown in the right image data. The three-dimensional data calculation unit 102 identifies the position of the working equipment 2 in the right image data defined in the camera coordinate system, based on the imaging device position data and the working equipment position data. As described above, the working equipment position data includes the working equipment data, and the working equipment data includes the design data of the working equipment 2, such as three-dimensional CAD data. The working equipment data also includes the outer shape data of the working equipment 2 and the dimensional data of the working equipment 2. Accordingly, the three-dimensional data calculation unit 102 may identify a pixel indicating the working equipment 2, among a plurality of pixels forming the right image data.

The three-dimensional data calculation unit 102 removes partial data including the working equipment 2 from the right image data based on the working equipment position data. In the same manner, the three-dimensional data calculation unit 102 removes partial data including the working equipment 2 from the left image data based on the working equipment position data (step SA30).

That is, the three-dimensional data calculation unit 102 invalidates the pixel, indicating the working equipment 2, used in the stereoscopic measurement process, among the plurality of pixels of the right image data. In the same manner, the three-dimensional data calculation unit 102 invalidates a pixel, indicating the working equipment 2, used in the stereoscopic measurement process, among a plurality of pixels of the left image data. In other words, the three-dimensional data calculation unit 102 removes or invalidates the image of the measurement point P, indicating the working equipment 2, projected onto the projection surface of the imaging device 30a, 30b.

The three-dimensional data calculation unit 102 calculates the target data, which is the three-dimensional data from which the working equipment 2 is removed, based on peripheral data that is image data from which the partial data including the working equipment 2 is removed (step SA40).

That is, the three-dimensional data calculation unit 102 calculates the target data, which is the three-dimensional data from which the working equipment 2 is removed, by performing three-dimensional processing based on two-dimensional peripheral data that is obtained by removing the partial data including the working equipment 2 from the right image data and two-dimensional peripheral data that is obtained by removing the partial data including the working equipment 2 from the left image data. The three-dimensional data calculation unit 102 calculates target data that is defined in the vehicle body coordinate system or the global coordinate system, by performing coordinate transformation on the target data that is defined in the camera coordinate system.

### Operations and Effects

As described above, according to the present embodiment, even if the working equipment 2 is included and shown, target data that is three-dimensional data from which at least a part of the working equipment 2 is removed is calculated based on the image data that is acquired by the image data acquisition unit 101 and the working equipment position data that is calculated by the working equipment position data calculation unit 107.

The working equipment 2 that is included and shown in the image data acquired by the imaging device 30 is a noise component. In the present embodiment, partial data including the working equipment 2, which is a noise component, is removed, and thus, the three-dimensional data calculation unit 102 may calculate desirable three-dimensional data of a work target based on the peripheral data. Moreover, desirable three-dimensional data of the work target is calculated even if the work target is captured by the imaging device 30 without raising the working equipment 2, and reduction in work efficiency is suppressed.

Additionally, in the present embodiment, the partial data is defined along an outer shape of the working equipment 2, as described with reference to FIG. 8. Instead, the partial data may include a part of the working equipment 2, and the peripheral data may include a part of the working equipment. Alternatively, the partial data may include a part of the work target.

### Second Embodiment

A second embodiment will be described. In the following description, structural elements the same or equivalent to those of the embodiment described above are denoted by the same reference signs, and a description thereof is simplified or omitted.

In the embodiment described above, the partial data is removed from the two-dimensional right image data and the two-dimensional left image data. In the present embodiment, an example will be described where three-dimensional data including the working equipment 2 is calculated based on the right image data and the left image data, and then, partial data including the working equipment 2 is removed from the three-dimensional data.

FIG. 9 is a flowchart illustrating an example of a shape measurement method according to the present embodiment. The image data acquisition unit 101 acquires right image data and left image data from the imaging devices 30 (step SB10).

The three-dimensional data calculation unit 102 calculates three-dimensional data of the work target by performing three-dimensional processing based on the right image data and the left image data acquired by the image data acquisition unit 101 (step SB20). The three-dimensional data calculation unit 102 calculates three-dimensional data of the work target in the camera coordinate system, and then, performs coordinate transformation and calculates three-dimensional data of the work target in the vehicle body coordinate system.

The three-dimensional data calculation unit 102 identifies the position of the working equipment 2 in the vehicle body coordinate system, based on the working equipment position data in the vehicle body coordinate system calculated by the working equipment position data calculation unit 107 (step SB30). The three-dimensional data calculation unit 102 identifies the position of the working equipment 2 in the camera coordinate system by performing coordinate transformation on the position of the working equipment 2 in the vehicle body coordinate system.

The three-dimensional data calculation unit 102 removes partial data (three-dimensional data) including the working equipment 2 identified in step SB30, from the three-dimensional data calculated in step SB20, and calculates target data that is the three-dimensional data from which the working equipment 2 is removed (step SB40).

That is, the three-dimensional data calculation unit 102 estimates a plurality of measurement points P indicating the working equipment 2, based on the working equipment position data, from three-dimensional point group data including a plurality of measurement points P acquired by three-dimensional processing, and removes three-dimensional partial data including the estimated plurality of measurement points P indicating the working equipment 2 from the three-dimensional point group data.

The three-dimensional data calculation unit 102 calculates target data that is defined in the vehicle body coordinate system or the global coordinate system, by performing coordinate transformation on target data that is defined in the camera coordinate system.

As described above, in the present embodiment, in the case where the working equipment 2 is included and shown in the image data captured by the imaging device 30, three-dimensional data including the working equipment 2 is calculated based on the right image data and the left image data, and then, partial data including the working equipment 2 is removed from the three-dimensional data. Also in the present embodiment, desirable three-dimensional data of a work target in front of the excavator 1 may be acquired while suppressing reduction in work efficiency.

Third Embodiment

A third embodiment will be described. In the following description, structural elements the same or equivalent to those of the embodiments described above are denoted by the same reference signs, and a description thereof is simplified or omitted.

In the embodiments described above, examples are described where the partial data including the working equipment 2 is removed. In the present embodiment, an example will be described where partial data including the other excavator 1ot is removed.

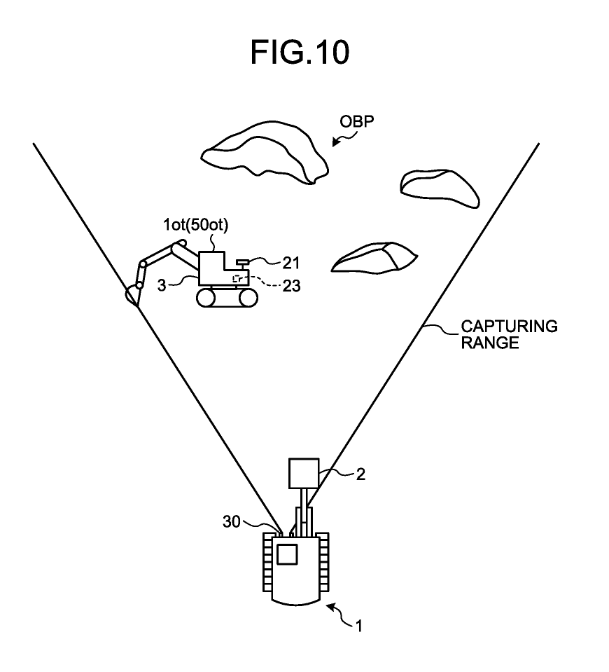

FIG. 10 is a diagram schematically illustrating an example of a shape measurement method according to the present embodiment. As illustrated in FIG. 10, when a work target OBP is captured by the imaging device 30 provided at the excavator 1, at least a part of the other excavator 1ot is possibly included and shown in image data that is captured by the imaging device 30. The other excavator 1ot that is included and shown in the image data captured by the imaging device 30 is a noise component, and makes acquisition of desirable three-dimensional data of the work target difficult.

In the present embodiment, the position data acquisition unit 103 acquires position data of the other excavator 1ot. The three-dimensional data calculation unit 102 calculates target data that is three-dimensional data from which at least a part of the other excavator 1ot is removed, based on image data that is acquired by the image data acquisition unit 101 and the position data of the other excavator 1ot that is acquired by the position data acquisition unit 103.

Like the excavator 1, the other excavator 1ot includes GPS antennas 21, and a position detector 23 for detecting a position of the vehicle. The other excavator 1ot sequentially transmits the position data of the other excavator 1ot detected by the position detector 23, to the server 61 over the communication network NTW.

The server 61 transmits the position data of the other excavator 1ot to the position data acquisition unit 103 of the detection processing device 51 of the excavator 1. The three-dimensional data calculation unit 102 of the detection processing device 51 of the excavator 1 identifies the position of the other excavator 1ot in the image data acquired by the image data acquisition unit 101, based on the position data of the other excavator 1ot, and calculates the target data that is the three-dimensional data from which at least a part of the other excavator 1ot is removed.

In the present embodiment, the three-dimensional data calculation unit 102 identifies a range of the other excavator 1ot in the image data acquired by the image data acquisition unit 101, based on the position data of the other excavator 1ot. The three-dimensional data calculation unit 102 may take a range of a predetermined distance having, at a center, the position data of the other excavator 1ot (for example, ±5 meters in each of the Xg-axis direction, the Yg-axis direction, and the Zg-axis direction, or a sphere with a radius of 5 meters) as the range of the other excavator 1ot in the image data, for example. The three-dimensional data calculation unit 102 may identify the range of the other excavator 1ot in the image data based on the image data acquired by the image data acquisition unit 101, the position data of the other excavator 1ot, and at least one of outer shape data and dimensional data, which are known data, of the other excavator 1ot. The outer shape data and the dimensional data of the other excavator 1ot may be held by the server 61 and be transmitted from the server 61 to the excavator 1, or may be stored in the storage unit 109.

Additionally, also in the present embodiment, partial data including the other excavator 1ot may be removed from two-dimensional right image data and two-dimensional left image data, or the partial data including the other excavator 1ot may be removed from three-dimensional data including the other excavator 1ot after calculating the three-dimensional data based on the right image data and the left image data.

As described above, according to the present embodiment, even if the other excavator 1ot is included and shown, partial data including the other excavator 1ot, which is a noise component, is removed, and thus, the three-dimensional data calculation unit 102 may calculate desirable three-dimensional data of the work target based on peripheral data.

In the embodiments described above, the working equipment position data in the vehicle body coordinate system is calculated, and in three-dimensional processing, the working equipment position data is coordinate-transformed into the camera coordinate system, and the partial data is removed in the camera coordinate system. Removal of the partial data may be performed in the vehicle body coordinate system or in the global coordinate system. Coordinate transformation may be performed as appropriate by removing the partial data in an arbitrary coordinate system.

The embodiments described above describe an example where four imaging devices 30 are provided at the excavator 1. It is sufficient if at least two imaging devices 30 are provided at the excavator 1.

In the embodiments described above, the server 61 may include a part or all of the functions of the detection processing device 51. That is, the server 61 may include at least one of the image data acquisition unit 101, the three-dimensional data calculation unit 102, the position data acquisition unit 103, the posture data acquisition unit 104, the orientation data acquisition unit 105, the working equipment angle data acquisition unit 106, the working equipment position data calculation unit 107, the display control unit 108, the storage unit 109, and the input/output unit 110. For example, the image data captured by the imaging device 30 of the excavator 1, the angle data of the working equipment 2 detected by the working equipment angle detector 22, the position data of the swinging body 3 detected by the position detector 23, the posture data of the swinging body 3 detected by the posture detector 24, and the orientation data of the swinging body 3 detected by the orientation detector 25 may be supplied to the server 61 through the communication device 26 and the communication network NTW. The three-dimensional data calculation unit 102 of the server 61 may calculate target data that is three-dimensional data from which at least a part of the working equipment 1 is removed, based on the image data and the working equipment position data.

Both the image data and the working equipment position data are supplied to the server 61 from the excavator 1 and a plurality of other excavators 1ot. The server 61 may collect three-dimensional data of a work target OBP over a wide range based on the image data and the working equipment position data supplied by the excavator 1 and a plurality of other excavators 1ot.

In the embodiments described above, the partial data including the working equipment 2 is removed from each of the right image data and the left image data. The partial image including the working equipment 2 may alternatively be removed from one of the right image data and the left image data. In the case where the partial data including the working equipment 2 is removed from one of the right image data and the left image data, the partial data of the working equipment 2 is not calculated at the time of calculation of the three-dimensional data.

In the embodiments described above, the measurement device for measuring the work target in front of the excavator 1 is the imaging device 30. Alternatively, the measurement device for measuring the work target in front of the excavator 1 may be a three-dimensional laser scanner. In such a case, three-dimensional shape data measured by the three-dimensional laser scanner is the measurement data.

In the embodiments described above, the work machine 1 is the excavator. The work machine 1 may be any work machine which is capable of working on a work target, and may be an excavation machine capable of excavating the work target, or a transporting machine capable of transporting soil. For example, the work machine 1 may be a wheel loader, a bulldozer, or a dump track.

### REFERENCE SIGNS LIST

1 excavator (work machine)

1B vehicle body

2 working equipment

3 swinging body

4 cab

4S driver's seat

4SS backrest

5 traveling body

6 boom

7 arm

8 bucket

8BT blade tip

10 boom cylinder

11 arm cylinder

12 bucket cylinder

13 boom pin

14 arm pin

15 bucket pin

16 boom stroke sensor

17 arm stroke sensor

18 bucket stroke sensor

21 GPS antenna

22 working equipment angle detector

23 position detector

24 posture detector

25 orientation detector

26 communication device

26A communication antenna

30 (30a, 30b, 30c, 30d) imaging device

31 hub

32 imaging switch

35 operation device

35L left operation lever

35R right operation lever

50 control system

51 detection processing device

57 construction management device

58 display device

59 signal line

61 server

62 communication device

63 communication antenna

64 mobile terminal device

65 display device

100 shape measurement system

101 image data acquisition unit (measurement data acquisition unit)

102 three-dimensional data calculation unit

103 position data acquisition unit

104 posture data acquisition unit

105 orientation data acquisition unit

106 working equipment angle data acquisition unit

107 working equipment position data calculation unit

108 display control unit

109 storage unit

110 input/output unit

AX1 rotation axis

AX2 rotation axis

AX3 rotation axis

NTW communication network

1. A detection processing device of a work machine comprising:
a measurement data acquisition unit which acquires measurement data of a target that is measured by a measurement device provided at a work machine;
a working equipment position data calculation unit which calculates working equipment position data indicating a position of a working equipment of the work machine; and
a three-dimensional data calculation unit which calculates target data that is three-dimensional data in which at least a part of the working equipment is removed, based on the measurement data and the working equipment position data.

2. The detection processing device of a work machine according to claim 1, wherein the three-dimensional data calculation unit removes partial data including the working equipment from the measurement data based on the working equipment position data, and calculates the target data based on the measurement data from which the partial data is removed.

3. The detection processing device of a work machine according to claim 2, wherein the three-dimensional data calculation unit identifies a position of the working equipment in the measurement data based on measurement device position data indicating a position of the measurement device and the working equipment position data.

4. The detection processing device of a work machine according to claim 1, wherein the working equipment position data calculation unit calculates the working equipment position data based on angle data of the working equipment, and outer shape data or dimensional data of the working equipment.

5. The detection processing device of a work machine according to claim 1, wherein the three-dimensional data calculation unit calculates the target data by removing, based on the working equipment position data, partial data including the working equipment from three-dimensional data that is calculated based on the measurement data.

6. A detection processing device of a work machine, comprising:
a measurement data acquisition unit which acquires measurement data of a target that is measured by a measurement device provided at a work machine;
a position data acquisition unit which acquires position data of another work machine; and
a three-dimensional data calculation unit which calculates target data that is three-dimensional data in which at least a part of the other work machine is removed, based on the measurement data and the position data of the other work machine.

7. The detection processing device of a work machine according to claim 6, wherein the three-dimensional data calculation unit calculates the target data based on the measurement data, the position data of the other work machine, and outer shape data or dimensional data of the other work machine.

8. A detection processing method of a work machine, comprising:
acquiring measurement data of a target that is measured by a measurement device provided at a work machine;
calculating working equipment position data indicating a position of a working equipment of the work machine; and
calculating target data that is three-dimensional data in which at least a part of the working equipment is removed, based on the measurement data and the working equipment position data.

9. A detection processing method of a work machine, comprising:
acquiring measurement data of a target that is measured by a measurement device provided at a work machine; and
calculating target data that is three-dimensional data in which at least a part of another work machine is removed, based on the measurement data and position data of the other work machine.
